(19) United States
(12) Patent Application Publication
(10) Pub. No.: US 2006/0112833 A1
(43) Pub. Date: Jun. 1, 2006

(54) Cooking by utilizing a cluster analysis and cooking utensils therefor

(75) Inventor: Gunter Blaschke, Buchloe-Honsolgen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: RATIONAL AG, Landsberg/Lech (DE)

(21) Appl. No.: 10/541,816

(22) PCT Filed: Jan. 7, 2004
(86) PCT No.: PCT/DE04/00003

§ 371 Date: Jul. 8, 2005

(30) Foreign Application Priority Data
Jan. 9, 2003 (DE) 103004653

(51) Int. Cl. A47J 37/12

(52) U.S. Cl. 99/325

(57) ABSTRACT

The invention relates to a method for cooking items that are to be cooked in a cooking chamber of a cooking utensil comprising a control and/or regulating mechanism which has access to primary, chronologically arranged measured data and secondary measured data of a state variable regarding at least one item that is to be cooked and/or a state variable regarding a cooking utensil, said secondary measured data not being chronologically arranged. The cooking process is carried out in the following steps according to said state variable/s: an actual cooking curve of the measured data Z, of the item (i) that is to be cooked is detected up to a specific point in time t<SB>M</SB> before the final cooking point t<SB>E</SB> is reached; the detected actual cooking curve Zᵢ is associated with a representative cooking profile Xₙ that is determined via a cluster analysis; and the cooking process is carried out according to the determined representative cooking profile Xₙ, wherein i and n∈|N. Also disclosed is a cooking utensil comprising a cooking chamber for receiving items that are to be cooked, a measuring device for detecting measuring data, a device for storing measured data and variables that are determined therefrom, and a control and/or regulating mechanism for directing the cooking process according to the inventive method.

### RELATED APPLICATIONS

This is the U.S. national phase of International Application No. PCT/DE2004/000003 filed Jan. 7, 2004, the entire disclosure of which is incorporated herein by reference and claims priority to German application 103 00 465.3 filed Jan. 9, 2003.

### FIELD OF DISCLOSURE

The invention concerns a method for cooking of items to be cooked in a cooking chamber of cooking apparatus with a control and/or regulation device, which has access to primary, measured data arranged according to time for at least one variable relating to an item to be cooked and/or cooking apparatus, as well as secondary measured data which are not ordered according to time, the cooking process being guided depending on these data, as well as a cooking apparatus with which such a method can be realized.

For example, a method is known from DE 197 18 399 A1 for the cooking of an item to be cooked in a cooking apparatus with a cooking chamber as well as a measuring device is known for recording at least one state variable of an item to be cooked and/or cooking apparatus, the cooking process being guided as a function of these. In this known method, the time of the end of the cooking process is determined based on values of at least one state variable of the item to be cooked, which is determined during the cooking process at different times, that is, not in test steps, as well as based on a predetermined end value of the state variable of the item to be cooked at the end of the cooking process, whereby the duration of time until reaching a specified end state of a said end value of the state of the item to be cooked is extrapolated and the extrapolation is based on the previous cooking process.

It is known from DE 196 09 116 A1 that, in a test step, the core temperature is scanned several times in succession until a defined point in time and with simultaneous consideration of the cooking chamber temperature belonging to the scanned core temperature, based on the scanned values, one can determine the end point in time at which such a target core temperature should be reached. This determination is done by solution of differential equations.

In U.S. Pat. No. 5,352,866 the determination of a cooking time is described more or less according to the principles of a proportional differential and integral regulator, based on stored time-temperature curves.

It is known from U.S. Pat. No. 4,970,359 and U.S. Pat. No. 4,682,013 that the cooking process can be divided into different sections, whereby measurement is performed up to a special point and then a regulation takes place based on special formulas and stored measured data.

In GB 2 203 320 A1 a comparison with a stored model curve is addressed generally.

It is known from EP 0 701 387 A2 to use a characteristic vector for the determination of a cooking course, which takes into consideration a maximum rate of change of moisture content, the value of the moisture content at its maximum rate of change, the time required to reach a certain moisture content value, and/or the mean moisture between two different points.

EP 0 550 312 A2 describes the control of a cooking process through briefly stored data.

In many areas of daily living and scientific research, it becomes necessary to divide as a rule, large sets of objects with the aid of test and experimental results, that is, properties, into a generally small number of groups, classes, clusters, heaps or the like, or to combine individual elements of the set of objects to groups, so that the individual groups are as homogeneous as possible but the differences between the groups are as large as possible. In this way such existing structures of the set of objects can be made recognizable and interpretable. Thus, for example, cluster analysis has already been used in empirical sciences, such as psychology, medicine, biology, geology, criminology and business management, see, for example, “Short-term simultaneous planning of sales, production and purchasing program in module-dependent seasonal undertakings as adaptive process” by Dr. Günter Blaschke, which appeared in Peter Lang, in the series of V Volks and Betriebswirtschaft, Volume 218, 1979. The task of cluster analysis is based on the fact that a set of objects, that is, carriers of variables, is given, each one of which has a certain measured value, that is, a manifestation of variable, with a number of properties, and groupings of the objects are searched for in which similarity exists in all properties to some degree.

In spite of the numerous known cooking process performance methods, there is still a demand for an optimized operation method.

### SUMMARY OF THE DISCLOSURE

Therefore, it is the task to provide an optimized method for individual operation of a cooking process.

This task is solved by the following steps:
Acquiring of the actual course of the cooking process with measured data Zᵢ of the item to be cooked i to a certain time point t_{M} before the cooking completion time t_{E},
Assignment of the acquired actual course of the cooking process Zᵢ to a representative cooking process Xₙ determined by cluster analysis, and
Guiding the cooking process as a function of the determined representative cooking profile Xₙ, where i and n∈|N

Hereby, it is proposed that in the cluster analysis at least one regression, one similarity comparison, a coefficient comparison, formation of a region, an interpolation and/or extrapolation is performed.

Here, the cluster analysis includes a standardization or making comparable the actual courses of the cooking process, especially by determination of an accumulated percentage Yᵢ of the 100% end value of measured data Zᵢ at the cooking completion time t_{E} as a function of tⱼ with j∈N where the 100% end value is preferably defined as the target quantity Zᵢ(t_{E}) at the cooking completion time t_{E}.

Here, it is proposed that the target quantity Zᵢ(t_{E}) be set or taken from a stored representative cooking profile Xₙ.

Again, it can be provided that the cluster analysis includes a classification of actual courses of the cooking process which were made comparable, especially by
Determination of the squares of the distance Aᵤ to the cooking completion time t_{E} with l∈|N, where

$${A}_{il} ( {t}_{E} ) = {\sum }_{j = 0}^{E} {( {Y}_{i} ( {t}_{j} ) - {Y}_{i} ( {t}_{j} ) )}^{2} ,$$
Determination of a number N of classes Kₙ with n={1, 2 . . . N} and
Defining each class Kₙ by a single or a respective maximum value of the square of the distance Aᵤ(tⱼ).

Here, the cluster analysis includes an assignment of a representative cooking profile Xₙ(tⱼ) to each class Kₙ, where a representative cooking profile Xₙ(tⱼ) is preferably determined by calculation of the mean value and/or of the centroid of the accumulated percentages Yᵢ(tⱼ) per class Kₙ or is called up from a storage device.

A preferred embodiment of the cooking method is characterized in that the assignment of an actual course of the cooking process Zᵢ to a representative cooking profile Xₙ(tⱼ) of a class Kₙ includes the following:
Determination of a value of deviation Sᵢₙ(t_{M}) for each class Kₙ within a

$${S}_{in} ( {t}_{M} ) = {\sum }_{j = 0}^{M} {( ( \frac{{Y}_{i} ( {t}_{j} )}{{X}_{n} ( {t}_{j} )} ) - ( \frac{{Y}_{i} ( {t}_{j + 1} )}{{X}_{n} ( {t}_{j + 1} )} ) )}^{2}$$

$$with {X}_{n} > 0 , and$$
Obtaining of the value of deviation Sᵢₙ(t_{M}) with the smallest value for the percentage Yᵢ(t_{M}) at time t_{M}.

Further, it can be provided that the guiding of the cooking process includes a prediction of measured data Zᵢ(t_{E}) at the cooking completion time t_{E} through the determined representative cooking profile Xₙ(tⱼ).

Here, it is proposed that the prediction include the following steps:
Assignment of the accumulated percentage Yᵢ(tⱼ) to a class Kₙ and thus to a representative cooking profile Xₙ(tⱼ),
Obtaining of a multiplier Pᵢₙ at the time t_{M}, where

$${P}_{in} = \frac{{Z}_{i} ( {t}_{M} )}{{X}_{n} ( {t}_{M} )}$$

$$where {X}_{n} > 0 , and$$
Extrapolation by multiplication of the end value Xₙ(t_{E}) of the representative cooking profile with the multiplier, where
   Xₙ(t_{E})Pᵢₙ=Zᵢ(t_{E}).

Furthermore, it is proposed that the weight loss of the item to be cooked, the core temperature of the item to be cooked, the diameter of the item to be cooked, the density of the item to be cooked, the type of item to be cooked, the degree of ripeness of the item to be cooked, the pH value of the item to be cooked, the consistency of the item to be cooked, the state of storage of the item to be cooked, the odor of the item to be cooked, the taste of the item to be cooked, the quality of the item to be cooked, the browning of the item to be cooked, the crust formation of the item to be cooked, the vitamin degradation of the item to be cooked, the formation of carcinogenic substances in the item to be cooked, the hygiene of the item to be cooked, the water activity of the item to be cooked, the moisture content of the item to be cooked, the protein content of the item to be cooked and the thermal conductivity of the item to be cooked each represent a state variable of the item to be cooked, which is obtained from the primary measured data.

It can be provided that the temperature in the cooking chamber, the humidity in the cooking chamber, and the air movement rate in the cooking chamber each represent a state variable of the cooking apparatus, which is obtained from the primary measured data.

It can also be provided that as secondary measured data, at least an apparatus input by a user, including the selection of a cooking program and/or a state variable of the item to be cooked at the end of the cooking time and/or state variable of the cooking apparatus at the end of the cooking time and/or at least an external circumstance, such as date, time, season, weather and/or geographic location is or are determined.

It is also proposed that each measured actual cooking course Zᵢ, each accumulated determined percentage Yᵢ and/or each determined representative cooking profile Xₙ is stored in a memory device, automatically or optionally.

Additionally, a cooking apparatus with a cooking chamber includes a measuring device for determining the measured data, a memory device for storing measured data and quantities determined from them and a control and/or regulating device for guiding a cooking process according to the method described above.

Hereby it can be provided that the measuring device and the control and/or regulating device is made into one, preferably also including the memory device, especially integrated in a cooking process sensor.

Thus, the cooking method and apparatus is based on the surprising finding that with the aid of cluster analysis, which is essentially known from empirical social research, cooking methods can be condensed, typified, profiled and mathematically unequivocally characterized as well as described in spite of its highly complex relationship of the items. As a result, the problem is reduced to a few key quantities to be defined, instead of isolation and consideration of an infinite number of individual influential quantities. In particular, new actual courses of the cooking process can be recognized early with the aid of their typical manifestations and can be assigned automatically to a representative cooking profile. Thus, an additional step is made in the direction of fully automatic cooking.

The totality of a set of data that belong to a cooking process, which represent a data packet, which contains not only primary measured data arranged in time, such as the weight loss of an item to be cooked, the core temperature of an item to be cooked, the humidity in the cooking chamber, the cooking chamber temperature or similar, but also secondary data, for example, the weather, the date, the geographic location or similar, which provide additional help in the automatic recognition of a useful goal. A cluster can be formed only when a sufficient amount of data packets which fulfill the common criteria for a cluster exist. Several mathematical methods can be used for clustering, such as regression, similarity comparison, interpolation and extrapolation or similar. When a comparison fulfills the typical common criteria, the cooking process is considered to be recognized. In addition, in case of positive comparison results, after conversion into a format typical to the cluster, the data packet can be added to the cluster so that a self-learning process takes place.

### BRIEF DESCRIPTION OF THE DRAWINGS

Other characteristics and advantages of the cooking method and apparatus follow from the description given below, in which a practical example of the cooking method and apparatus is explained in detail with the aid of schematic drawings. The following are shown:

FIGS. 1a and 1b A typical expression of the characteristics or a typical progress of primary measured data as a function of the cooking time;

FIG. 2 The accumulated percentage of an actual course of the cooking process based on the predetermined 100% end value, as a function of the cooking time to the cooking completion time;

FIG. 3 Two curves according to FIG. 2 to explain the classification used in a cooking method; and

FIG. 4 an actual course of the cooking process in comparison to a representative cooking profile for illustration of the operation of a cooking process.

### DETAILED DESCRIPTION

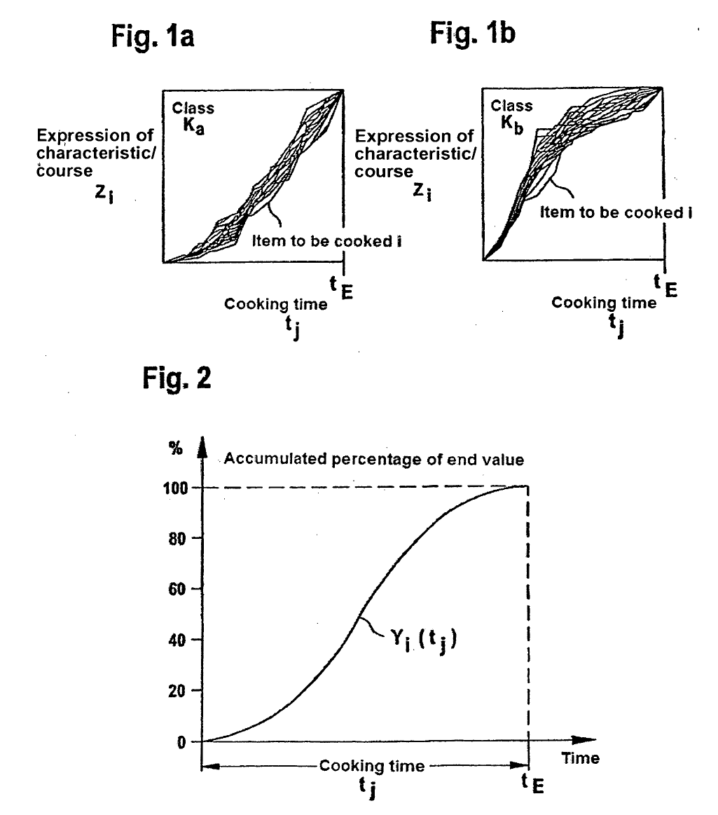

FIG. 1a shows actual courses of the cooking process for different items to be cooked i, which are assigned to a class Kₙ and, for example, only primary measured data Zᵢ, such as in the form of the weight loss of an item to be cooked are represented. FIG. 1b shows actual courses of the cooking process as primary measured data Zᵢ for a number of items to be cooked i, of a second class Z_{b}, analogously to FIG. 1a. FIGS. 1a and 1b illustrate using the course of primary measured data Zᵢ, in a comparison, how different cooking process characteristics can be expressed for the cooking time tⱼ for two different items to be cooked classes Kₐ and K_{b}. At the same time, however, FIGS. 1a and 1b also show that different items to be cooked i, within a class Kₐ and K_{b}, respectively, do not necessarily have to have different actual courses of the cooking process with regard to a state variable Zᵢ of an item to be cooked, such as in the form of the weight loss of the item to be cooked i. Rather, actually items to be cooked can be assigned to certain classes of items to be cooked Kₙ for which a certain cooking profile Xₙ is typical with regard to one or more measured criteria, especially the state variable Zᵢ for the item to be cooked. In the following, it is assumed that the state variable Zᵢ of the item to be cooked is the weight loss Zᵢ of the item to be cooked i.

The actual courses of the cooking process of the weight loss Zᵢ of different items to be cooked i must be made comparable to one another within the framework according to the cluster analysis. For this reason, the actual courses of the cooking process must be represented in a form from which the characteristics of this can be derived. For this purpose, according to the invention the determination of the accumulated percentage Yᵢ, for example, of a 100% end value of the weight loss Zᵢ(t_{E}) which is given as target value at the cooking completion time T_{E} is suitable. The target value can be entered, for example, for a table manually for the particular item to be cooked in cooking apparatus not shown here. In FIG. 2 an accumulated percentage Yᵢ(tⱼ) for the item to be cooked i is represented as a function of time tⱼ.

In order to be able to use cluster analysis in the operation of a cooking process, a sensible measure of the similarity must be defined. For this purpose, the complete cooking time until the cooking completion time t_{E} is divided into a suitable number of intervals j, for example, 10 intervals, and for each time interval tⱼ a sum of the square of distance Aᵢₗ of two accumulated percentage curves Yᵢ(tⱼ) and Yₗ(tⱼ) is calculated, namely as follows

$${A}_{il} ( {t}_{E} ) = {\sum }_{j = 0}^{E} {( {Y}_{i} ( {t}_{j} ) - {Y}_{i} ( {t}_{j} ) )}^{2} .$$

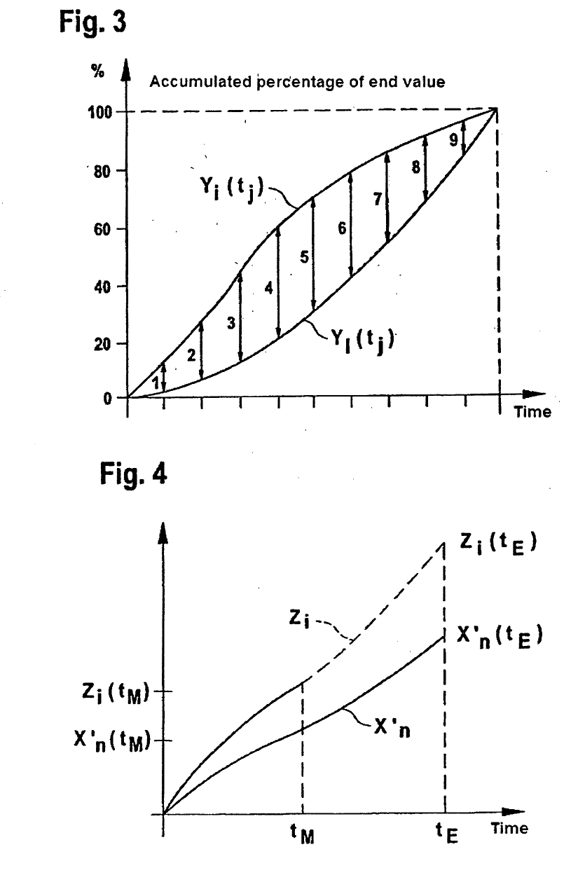

FIG. 3 illustrates the determination of the sum of the square of distance Aᵢₗ(t_{E}) from the differences of the two accumulated percentage curves Yᵢ(tⱼ) and Yₗ(tⱼ) for each time interval tⱼ, after squaring and summation.

Depending on a sensible number N of classes Kₙ for the items to be cooked i, for example 10 classes, a permissible maximum value for the sum of the square of distance Aᵢₗ(t_{E}) must be determined for dividing the actual courses of the cooking process Zᵢ into different classes Kₙ, so that in a class Kₙ all those items to be cooked i, are included for which the sum of the square distance Aᵢₗ(t_{E}) are below the maximum value. Then, within a class Kₙ there is a great degree of similarity of the course of the weight loss Zᵢ, while between the classes Kₙ there is a small degree of similarity. For each class Kₙ a representative is also determined, that is, a representative cooking profile Xₙ(tⱼ), from which the centroid of the percentages Yᵢ(tⱼ) for each time interval tⱼ is determined.

After the determination of the classes Kₙ and determination of the representative cooking profile Xₙ(tⱼ) according to cluster analysis, including storage, for each item to be cooked i independently of the cooking apparatus, originally a comparison can be made between a detected actual course of the cooking process and the stored representative cooking profiles Xₙ(tⱼ) in order to operate the cooking process. For this purpose, for each class Kₙ within a determined time interval t_{M} with t_{M}<t_{E}, a deviation value Sᵢₙ(t_{M}) is determined as follows:

$${S}_{in} ( {t}_{M} ) = {\sum }_{j = 0}^{M} {( ( \frac{{Y}_{i} ( {t}_{j} )}{{X}_{n} ( {t}_{j} )} ) - ( \frac{{Y}_{i} ( {t}_{j + 1} )}{{X}_{n} ( {t}_{j + 1} )} ) )}^{2} .$$

The per actual course of the cooking process, represented as accumulate percentage Yᵢ(tⱼ) to the end value t_{E}, the representative cooking profile Xₙ(tⱼ) is selected from all the deviation values Sᵢₙ(t_{M}) at which the deviation value Sᵢₙ(t_{M}) is the smallest. As a result of this assignment, now the end value of the detected state variables Zᵢ(t_{E}), that is, of the weight loss, can be predicted with the aid of the corresponding representative cooking profile Xₙ(tⱼ). It can be assumed here that the actual course of the cooking process Yⱼ(t_{M}) detected at the time t_{M}, that is, an incomplete course, and the representative cooking profile Xₙ(t_{M}) determined at the time t_{M} have a similar course to the cooking completion time t_{E}, namely, they differ exclusively by a multiplication constant Pᵢₙ. This constant Pᵢₙ at time t_{M} is calculated as follows:

$${P}_{in} = \frac{{Y}_{i} ( {t}_{M} )}{{X}_{n} ( {t}_{M} )} .$$

Finally, in order to operate the cooking process according to the invention, only the determined constant Pᵢₙ needs to be multiplied with the value of the representative cooking profile Xₙ at the cooking completion time t_{E}, namely, as follows:
Xₙ(t_{E})Pᵢₙ=Yᵢ(t_{E}).

The just-described prediction of a state variable Zᵢ, such as the weight loss of the item to be cooked i at the cooking completion time t_{E} after the acquiring of an actual course of the cooking process to time t_{M} and assignment of this to a representative cooking profile is illustrated in FIG. 4, where the selected representative cooking profile Xₙ was recalculated from the representation as an accumulated percentage to a representative course of the weight loss X′ₙ.

Thus, in summary, it can be stated that with a cluster analysis an automatic recognition of product and operation of cooking process is possible by assignment of an actual course of the cooking process which is measured at a time t_{M} to a previously-determined representative cooking profile.

The characteristics of the invention which are disclosed in the above specification, in the claims as well as in the drawing, can be essential both individually as well as in any arbitrary combination for the realization of the invention in its different embodiments.

1. Method for cooking of items in a cooking chamber of a cooking apparatus with a control or regulation device, which has access to primary measured data arranged in time as well as to secondary measured data which are not arranged in time, of at least one state variable of an item to be cooked or of the cooking apparatus, the method comprising:
acquiring an actual course of a cooking process of the measured data Zᵢ of the item to be cooked i up to a predefined time t_{M} before a cooking completion time t_{E},
assigning the acquired actual course of cooking process Zᵢ to a representative cooking profile Xₙ determined through cluster analysis, where the cluster analysis includes standardization of the actual cooking courses or making them comparable, and
guiding the cooking process as a function of the determined representative cooking profile Xₙ, where i and n∈|N.

2. Method according to claim 1, wherein the cluster analysis includes at least one of a regression analysis, or a similarity comparison, or a coefficient comparison, or a formation of a range, or an interpolation or an extrapolation.

3. Method according to claim 1, wherein the actual cooking courses are standardized or made comparable, by determining an accumulated percentage Yᵢ from the 100% end value of the measured data Zᵢ at the cooking completion time t_{E} as a function of time tⱼ with j∈|N, where the 100% end value is defined as a target quantity Zᵢ(t_{E}) at the cooking completion time t_{E}.

4. Method according to claim 3, wherein the target quantity Zᵢ(t_{E}) is adjusted or taken from a stored representative cooking profile Xₙ.

5. Method according to claim 1, wherein the cluster analysis includes classifying actual courses of the cooking process made comparable, including,
determining the sums of the squares of a distance Aᵢₗ to the end time of cooking t_{E} with l∈|N, where
$${A}_{il} ( {t}_{E} ) = {\sum }_{j = 0}^{E} {( {Y}_{i} ( {t}_{j} ) - {Y}_{i} ( {t}_{j} ) )}^{2} ,$$
determining a number N of classes Kₙ with n={1, 2 . . . N}, and
defining each class Kₙ through a single or a respective maximum value of the sum of the squares of the distance Aᵢᵢ(t_{E}).

6. Method according to claim 5, wherein the cluster analysis includes the assignment of a representative cooking profile Xₙ(tⱼ) to each class Kₙ.

7. Method according to claim 6, wherein the assignment of an actual course of the cooking process Zᵢ to a representative cooking profile Xₙ(tⱼ) of a class Kₙ includes:
determining a value of deviation Sᵢₙ(t_{M}) for each class Kₙ within a time interval t_{M}, where
$${S}_{in} ( {t}_{M} ) = {\sum }_{j = 0}^{M} {( ( \frac{{Y}_{i} ( {t}_{j} )}{{X}_{n} ( {t}_{j} )} ) - ( \frac{{Y}_{i} ( {t}_{j + 1} )}{{X}_{n} ( {t}_{j + 1} )} ) )}^{2} with {X}_{n} > 0 , and$$
obtaining the value of deviation Sᵢₙ(t_{M}) with the value of the smallest magnitude for the percentage Yᵢ(t_{M}) at time t_{M}.

8. Method according to claim 1, wherein the guiding of the cooking process includes predicting measured data Zᵢ(t_{E}) at an end of cooking time t_{E} through the determined representative cooking profile Xₙ(tⱼ).

9. Method according to claim 8, wherein predicting includes:
assigning the accumulated percentages Yᵢ(tⱼ) to a class Kₙ and thus to a representative cooking profile Xₙ(tⱼ),
obtaining a multiplier Pᵢₙ at time t_{M} where
$${P}_{in} = \frac{{Z}_{i} ( {t}_{M} )}{{X}_{n} ( {t}_{M} )} , where {X}_{n} > 0 and$$
extrapolating by multiplication of the end value Xₙ(t_{E}) of the representative cooking profile with the multiplier Pᵢₙ, where
Xₙ(t_{E})Pᵢₙ=Zᵢ(t_{E})

10. Method according to claim 1, wherein a state variable of the item to be cooked obtained from the primary measured data includes one or more of the weight loss of the item to be cooked, the core temperature of the item to be cooked, the diameter of the item to be cooked, the density of the item to be cooked, the type of item to be cooked, the degree of ripeness of the item to be cooked, the pH value of the item to be cooked, the consistency of the item to be cooked, the state of storage of the item to be cooked, the odor of the item to be cooked, the taste of the item to be cooked, the quality of the item to be cooked, the browning of the item to be cooked, the crust formation of the item to be cooked, the vitamin degradation of the item to be cooked, the formation of carcinogenic substances in the item to be cooked, the hygiene of the item to be cooked, the water activity of the item to be cooked, the moisture content of the item to be cooked, the protein content of the item to be cooked, or the thermal conductivity of the item to be cooked.

11. Method according to claim 1, wherein a cooking apparatus state variable determined from the primary measured data includes one or more of the temperature in the cooking chamber, or the moisture in the cooking chamber or the air movement rate in the cooking chamber.

12. Method according to claim 1, including determining, as secondary measured data, at least one apparatus input by a user.

13. Method according to claim 1, wherein each measured actual course of the cooking process Zᵢ, each determined accumulated percentage Yᵢ or each determined representative cooking profile Xₙ is stored in a memory device, automatically or optionally.

14. Cooking apparatus with a cooking chamber for holding an item to be cooked, comprising:
a measuring device for determining measured data,
a memory device for storing measured data and quantities determined from the measured data, and
a control or regulation device for guiding a cooking process by,
acquiring an actual course of a cooking process of measured data of the item to be cooked up to a predefined time before a cooking completion time,
assigning the acquired actual course of the cooking process to a representative cooking profile determined through cluster analysis, and
guiding the cooking process as a function of the determined representative cooking profile.

15. Cooking apparatus according to claim 14, wherein the measuring device and the control or regulation device are constructed as one.

16. Cooking apparatus according to claim 15, wherein the memory device is integrated with the measuring device and the control or regulation device.

17. Cooking apparatus according to claim 16, wherein the memory device, the measuring device and the control or regulation device are integrated in a cooking process sensor.

18. Method according to claim 1, wherein the cluster analysis includes classifying actual cooking courses made comparable.

19. Method according to claim 1 wherein the cluster analysis includes a standardization of actual courses of the cooking process or making them comparable by determining an accumulated percentage Yᵢ from the 100% end value of the measured data Zᵢ(t_{E}) at the cooking completion time t_{E} as a function of time tⱼ with j∈|N.

20. Method according to claim 6, wherein a representative cooking profile Xₙ(tⱼ) is determined by calculating a mean value or a centroid of the accumulated percentages Yᵢ(tⱼ) per class Kₙ or the representative cooking profile Xₙ(tⱼ) is recalled from a memory device.

21. Method according to claim 12, wherein the at least one apparatus input by a user includes the selection of a cooking program or a state variable of an item to be cooked at the end of the cooking, time or a state variable of the cooking apparatus at the end time of cooking time.

22. Method according to claim 12, wherein the external factor includes one or more of a date, or a time, or a season, or a weather or a geographical location.
